(19) United States
(12) Patent Application Publication
(10) Pub. No.: US 2008/0047975 A1
(43) Pub. Date: Feb. 28, 2008

(54) Air separation valve

(76) Inventors: Marie Hakansson, Malmo (SE); Bengt I. Larsson, Skivarp (SE); Mattias Martensson, Sjobo (SE)

Correspondence Address: FISH & RICHARDSON P.C., P.O. BOX 1022, MINNEAPOLIS, MN, 55440-1022, US

(21) Appl. No.: 11/805,783

(22) Filed: May 24, 2007

(30) Foreign Application Priority Data
May 30, 2006 (EP) 06114697.3

(51) Int. Cl. B67D 5/16

(52) U.S. Cl. 222/72

(57) ABSTRACT

A fuel dispensing unit for refueling vehicles comprises a pump for drawing fuel from a storage tank to a dispensing nozzle, and an air separator in fluid communication with the pump and arranged downstream the pump for removing gaseous fluid from the fuel. The air separator comprises a gaseous fluid outlet for letting out a gaseous fluid stream, and a fuel outlet for letting out a fuel stream. A valve is configured to control a flow of the gaseous fluid stream passing through the gaseous fluid outlet, said control being based on the amount of gaseous fluid.

### CLAIM OF PRIORITY

This application claims priority under 35 USC §119 to European Patent Application No. 06114697.3, filed on May 30, 2006, the entire contents of which are hereby incorporated by reference.

### TECHNICAL FIELD

The present invention relates to a fuel dispensing unit comprising a pump for drawing fuel from a storage tank to a dispensing nozzle. An air separator is in fluid communication with the pump for removing gaseous fluid from the fuel and comprises a gaseous fluid outlet for discharging a gaseous fluid stream, and a fuel outlet for discharging a fuel stream.

### BACKGROUND ART

When a fuel dispensing unit is used for filling a fuel tank of a vehicle, entrained gas may form in the fuel when it is pumped or transported along the fuel line, from a fuel storage tank to a nozzle of the fuel dispensing unit. Some of the reasons for gas formation may be wake caused by moving parts such as pumps, vortexes and regions of low pressure along the fluid pathway, any unattended leakage, etc.

Various techniques are available to separate gas, such as vapor, air or any other gas, from fuel dispensed from a fuel dispensing unit to a vehicle. This separation is important since a fuel flow meter, which cannot differentiate between the liquid fuel and any entrained gas, will produce an erroneous reading for the volume of fuel dispensed if the fuel is contaminated with gas. After air separation, a person purchasing the fuel pays only for the fuel dispensed and not for any gas previously entrained therein.

U.S. Pat. No. 5,884,809 discloses a fuel dispensing system incorporating a centrifugal air separator for separating gas entrained in the fuel. The air separator has an inlet for gas-contaminated fuel, an outlet for deaerated fuel and a bleed tube for letting out separated gas. Downstream of the air separator the deaerated fuel flows through a fuel line and exits through a dispensing nozzle. A complex valve arrangement controls the flow of deaerated fuel flowing to the dispensing nozzle, and if gas contamination reaches a specific level, the fuel flow to the nozzle is stopped.

A general problem with existing devices for gas separation and means for detecting the presence of gas is that they are relatively complicated and expensive both in respect of construction and production.

Another problem is that gas is not sufficiently separated from the fuel. This causes operational disturbances and increases the cost of operation. A customer may also unintentionally pay for air entrained in the fuel.

### SUMMARY OF THE INVENTION

It is an object of the present invention to provide an improvement of the above techniques and prior art.

A particular object is to provide a fuel dispensing unit which more efficiently separates gas from fuel that is being dispensed.

These and other objects as well as advantages that will be apparent from the following description of the present invention are achieved by a fuel dispensing unit according to the description below.

A fuel dispensing unit for refueling vehicles is described. The fuel dispensing unit comprises a pump for drawing fuel from a storage tank to a dispensing nozzle, and an air separator in fluid communication with the pump and arranged downstream the pump for removing gaseous fluid from the fuel. The air separator comprises a gaseous fluid outlet for letting out a gaseous fluid stream and a fuel outlet for letting out a fuel stream. A valve is arranged and configured to control a flow of the gaseous fluid stream passing through the gaseous fluid outlet, said control being based on the amount of gaseous fluid.

As used herein, the term “gaseous fluid stream” and means a stream of fluid that consists of a mixture of fuel and gaseous fluid, while the term “fuel stream” means a stream of fluid that consists mostly of liquid fuel and has a relatively lower content of gaseous fuel, as compared with the “gaseous fluid stream”.

The fuel dispensing unit according to the invention is highly advantageous by controlling the flow of the gaseous fluid stream passing through the gaseous fluid outlet. Of course, the control results in the flow being increased or decreased, and the control is, as mentioned, based on the amount of gaseous fluid present in the fuel.

When the amount of gaseous fluid is high, the flow of the gaseous fluid stream is increased, making it possible to separate more entrained gas from the fuel, which thereby makes it possible for the fuel dispensing unit to handle fuel having a relatively high level of gaseous contaminants.

When the amount of gaseous fluid is low, the flow of the gaseous fluid stream is decreased, which thereby prevents too much fuel to exit, together with any separated gas, through the gaseous fluid outlet.

The control of the gaseous fluid stream may be based on any of the amount of gaseous fluid in the gaseous fluid stream, a pressure of the gaseous fluid stream, the density of the gaseous fluid stream and the mass-flow of the gaseous fluid stream, which renders it possible to provide a cost efficient control mechanism. This also makes measurement of the amount of gaseous fluid at another position along the fuel line unnecessary.

The valve may be arranged in a flow path of the gaseous fluid stream, said flow path being in fluid communication with the gaseous fluid outlet, which provides for efficient detection of the amount of gaseous fluid as well as efficient control of the gaseous fluid stream.

The gaseous fluid outlet may comprise a bleed tube, which ensures a compact design.

The valve may comprise a first outlet for the gaseous fluid stream, said first outlet being open only when the amount of gaseous fluid in the fuel is above a predetermined level, for efficiently facilitating an increase of the gaseous fluid stream.

The valve may comprise a second outlet for the gaseous fluid stream, said second outlet being continuously open, which provides a configuration efficiently allowing normal (low level gas contamination) operation of the valve.

The valve may comprise a through hole for allowing passage of the gaseous fluid stream, and the cross-sectional area of the through hole may decrease in a direction of the flow of the gaseous fluid stream, which provides for the gaseous fluid stream efficiently applying a pressure on the valve.

The valve may comprise a valve body movably arranged in a valve housing for efficient control of the valve.

The valve housing may comprise a bleed tube in fluid communication with the gaseous fluid outlet for a compact and cost efficient design.

The valve body may comprise an outlet arranged to align with an opening of the valve housing when the amount of gaseous fluid is above a predetermined level. This ensures efficient control of the flow of the gaseous fluid stream.

A flow passage for the gaseous fluid stream may be formed between the valve housing and the valve body, said flow passage being continuously open when the amount of gaseous fluid is above a predetermined level, which provides a further configuration allowing the gaseous fluid stream to efficiently apply a pressure to the valve body.

The valve may comprise a resilient element, and the resilient element may be arranged to bias a valve body in a direction against the flow of the gaseous fluid stream. This provides for a configuration where the resilient element efficiently applies a force to the valve body, which counteracts a force applied to the valve body by the pressure of the gaseous fluid stream.

The valve may be configured to control the flow of the gaseous fluid stream passing through the gaseous fluid outlet by increasing or decreasing the number of open flow passage openings of the valve.

### BRIEF DESCRIPTION OF THE DRAWINGS

Embodiments of the present invention will now be described, by way of example, with reference to the accompanying figures, in which

FIG. 1 is a schematic view of a fuel dispensing unit,

FIG. 2 is a cross-sectional view of a pump housing,

FIG. 3 is a cross-sectional view of a valve in a first position, and

FIG. 4 is a cross-sectional view of a valve in a second position.

### DETAILED DESCRIPTION OF THE EMBODIMENTS

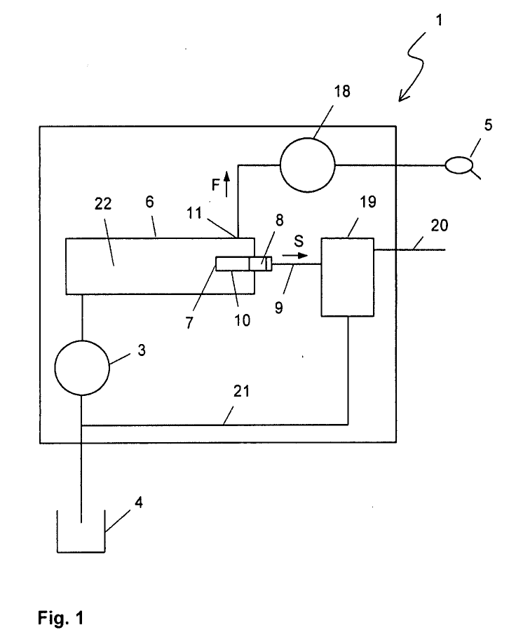

With reference to FIG. 1, a fuel dispensing unit 1 comprises a fuel pump 3 arranged to draw fuel from a storage tank 4, and to feed the fuel to an air separator 6 connected downstream the pump 3. The air separator 6 separates in a known manner gaseous fluid entrained in the fuel and comprises a centrifugal chamber 22, a gaseous fluid outlet 12; 13, or centrifugal chamber outlet, for letting out/discharging a stream S of separated gas, and a fuel outlet 11 for letting out/discharging a stream F of deaerated, liquid fuel.

Downstream the fuel outlet 11 of the air separator 6 a fuel meter 18 is arranged for measuring the amount of fuel being dispensed through a fuel dispensing nozzle 5.

The gaseous fluid outlet 12; 13 of the air separator 6 is, via a flow path 9, in fluid communication with an air separation chamber 19 receiving the gaseous fluid stream S. The gaseous fluid stream S commonly comprises both gaseous fluid and fuel, and from the air separation chamber 19 the gaseous fluid is vented via a gaseous exit 20. Fuel collected in the air separation chamber 19 is recirculated via a return path 21 connected to the pump 3, downstream the pump 3.

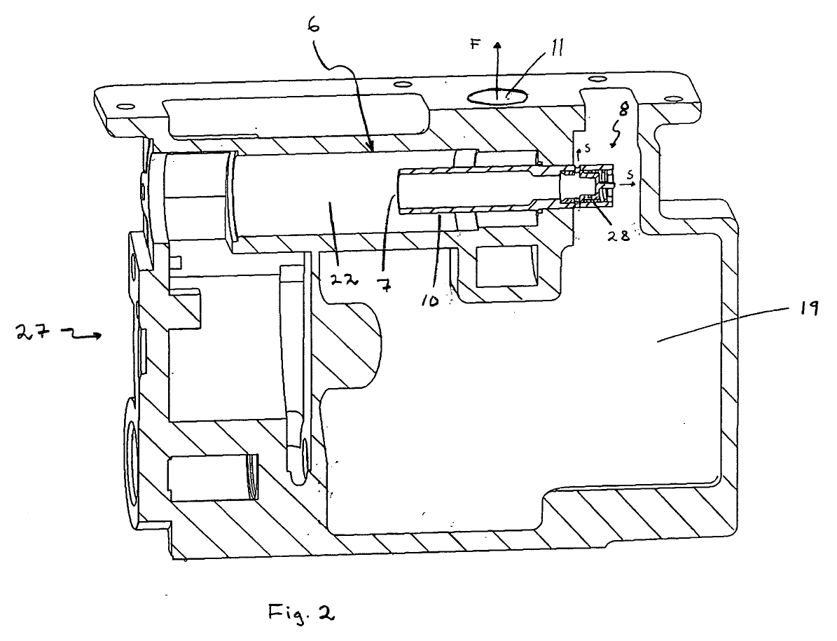

With further reference to FIGS. 2 to 4 the air separator 6 comprises a cylindrical bleed tube 10 with an inlet 7. A valve 8 is arranged downstream the bleed tube inlet 7 and comprises a cylindrical valve body 28 slidably arranged in a cylindrical valve housing 15 which is integrated with the bleed tube 10. A compression spring 14 is arranged between a protrusion 23 of the valve housing 15 and the valve body 28 and biases the valve body 28 in a direction against the flow of the gaseous fluid stream S. Of course, the direction of the flow of the gaseous fluid stream is from the air separator 6, past the gaseous fluid outlet 12; 13, towards the air separation chamber 19.

The centrifugal chamber 22, the bleed tube 10 and the valve 8 are preferably arranged in a pump hosing 27 as illustrated in FIG. 2.

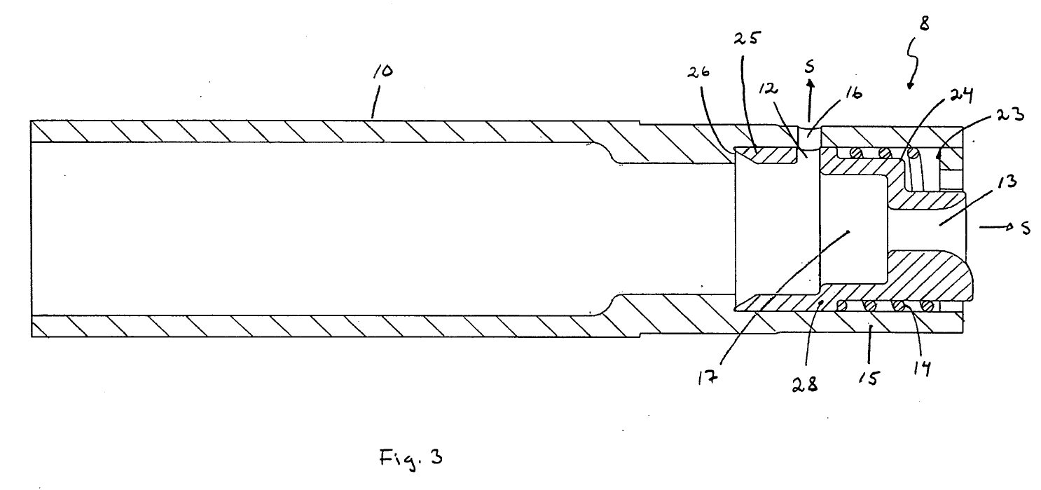

The valve body 28 has a first outlet 12 transversely to the axis of the valve housing 15, and a second outlet 13 parallel with the axis of the valve housing 15. Any of these openings 12, 13 represent the gaseous fluid outlet of the air separator 6. The valve housing 15 has an opening 16, and in a valve-open position as illustrated in FIG. 3, the first outlet 12 of the valve body 28 aligns with the opening 16 of the valve housing 15. In this valve-open position, the gaseous fluid stream S flows both through the first outlet 12 and through the second outlet 13, and into the air separation chamber 19.

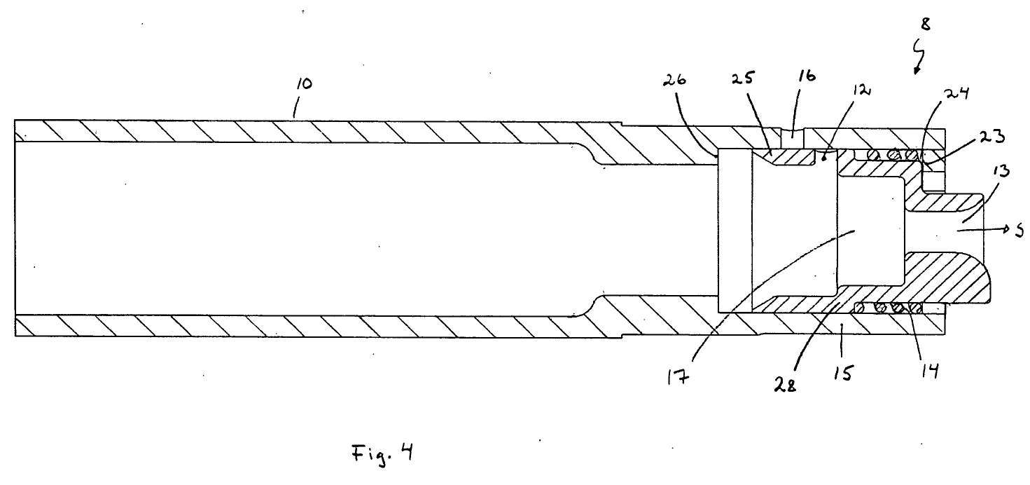

In a valve-closed position as illustrated in FIG. 4, the first outlet 12 is offset relative to the opening 16 of the valve housing 15, preventing the gaseous fluid stream S to flow through the first outlet 12. In this case the gaseous fluid stream S is reduced and flows to the air separation chamber 19 only via the second outlet 13.

When the fuel dispensing unit 1 is operated, fuel flows through the centrifugal chamber 22 and any entrained gas bubbles form in a known manner a vortex and enter the bleed tube 10.

Under normal conditions, the amount of gas in the fuel is low, resulting in the gaseous fluid stream S consisting of mostly liquid fuel and exerting a normal pressure on the valve body 28, pressing it in a direction of the flow of the gaseous fluid stream S, which results in the valve-closed position described above. In this case, a shoulder 24 of the valve body 28 rests on the protrusion 23 of the valve housing 15, limiting the movement of the valve body 28 in a direction of the flow of the gaseous fluid stream S.

When the amount of gas in the fuel is high, more gaseous fluid is present in the gaseous fluid stream S. Since gaseous fluid has a lower density (or mass flow) than liquid fluid, the gaseous fluid stream S now exerts a lower pressure on the valve body 28. When a lower pressure is exerted on the valve body 28, the compression spring 14 presses the valve body 28 in a direction against the flow of the gaseous fluid stream S, which results in the valve-open position described above. In this case, a base part 25 of the valve member 8 rests on a projection 26 of the valve housing 15, limiting the movement of the valve member in a direction against the flow of the gaseous fluid stream S. Of course, the spring constant of the compression spring 14 is selected so that the valve body 28 is pressed to the valve-closed position when the amount of gas exceeds a specific level.

The valve body 28 may, of course, comprise a third outlet (not shown) arranged in a manner similar to the first outlet 12, and the valve housing 15 may comprise an associated second opening (not shown) similar to the opening 16, for providing an increased flow of the gaseous fluid stream S.

It is also possible to form the first outlet 12 of the valve body 28 and the corresponding opening 16 of the valve housing 15 as, for example, slots aligned in direction of the movement of the valve body 28, for providing a variable flow depending on the pressure exerted by the gaseous fluid stream S.

It is also possible to control the valve 8 based on the amount of gaseous fluid detected in the fuel elsewhere along the fuel line.

In a variant, a flow passage (not shown) for the gaseous fluid stream S is formed between the valve housing 15 and the valve body 28. This flow passage has a function corresponding to the second outlet 13 and may either complement or replace the second outlet 13.

Of course, the valve housing 15 does not have to be integrated with the bleed tube 10, but may be arranged anywhere between the bleed tube 10 and the air separation chamber 19.

1. A fuel dispensing unit for refueling vehicles, said fuel dispensing unit comprising
a pump for drawing fuel from a storage tank to a dispensing nozzle, and
an air separator in fluid communication with the pump and arranged downstream the pump for removing gaseous fluid from the fuel,
said air separator comprising a gaseous fluid outlet for letting out a gaseous fluid stream and a fuel outlet for letting out a fuel stream,
wherein a valve is arranged to control a flow of the gaseous fluid stream passing through the gaseous fluid outlet, said control being based on the amount of gaseous fluid.

2. A fuel dispensing unit according to claim 1, wherein said control is based on the amount of gaseous fluid in the gaseous fluid stream.

3. A fuel dispensing unit according to claim 1, wherein said control is based on a pressure of the gaseous fluid stream.

4. A fuel dispensing unit according to claim 1, wherein said control is based on any of the density and the mass-flow of the gaseous fluid stream.

5. A fuel dispensing unit according to claim 1, wherein the valve is arranged in a flow path of the gaseous fluid stream, said flow path being in fluid communication with the gaseous fluid outlet.

6. A fuel dispensing unit according to claim 1, wherein the gaseous fluid outlet comprises a bleed tube.

7. A fuel dispensing unit according to claim 1, wherein the valve comprises a first outlet for the gaseous fluid stream, said first outlet being open when the amount of gaseous fluid in the fuel is above a predetermined level.

8. A fuel dispensing unit according to claim 1, wherein the valve comprises a second outlet for the gaseous fluid stream, said second outlet being continuously open.

9. A fuel dispensing unit according to claim 1, wherein the valve comprises a through hole for allowing passage of the gaseous fluid stream.

10. A fuel dispensing unit according to claim 1, wherein the cross-sectional area of the through hole decreases in a direction of the flow of the gaseous fluid stream.

11. A fuel dispensing unit according to claim 1, wherein the valve comprises a valve body movably arranged in a valve housing.

12. A fuel dispensing unit according to claim 11, wherein the valve housing comprises a bleed tube in fluid communication with the gaseous fluid outlet.

13. A fuel dispensing unit according to claim 11, wherein the valve body comprises an outlet arranged to be aligned with an opening of the valve housing, when the amount of gaseous fluid is above a predetermined level.

14. A fuel dispensing unit according to claim 11, wherein a flow passage for the gaseous fluid stream is formed between the valve housing and the valve body, said flow passage being continuously open, when the amount of gaseous fluid is above a predetermined level.

15. A fuel dispensing unit according to claim 1, wherein the valve comprises a resilient element.

16. A fuel dispensing unit according to claim 15, wherein the resilient element is arranged to bias a valve body in a direction against a flow of the gaseous fluid stream.

17. A fuel dispensing unit according to claim 1, wherein the valve is configured to control the flow of the gaseous fluid stream passing through the gaseous fluid outlet, by increasing or decreasing the number of open flow passage openings of the valve.
